(19) United States
(12) Patent Application Publication
(10) Pub. No.: US 2012/0193921 A1
(43) Pub. Date: Aug. 2, 2012

(54) SYSTEMS AND DEVICES FOR HARNESSING ENERGY FROM TIDAL MOVEMENTS

(76) Inventor: Ricardo Carlos Kelly, Kissimmee, FL (US)

(21) Appl. No.: 13/204,637

(22) Filed: Aug. 5, 2011

Related U.S. Application Data
(60) Provisional application No. 61/371,000, filed on Aug. 5, 2010.

(51) Int. Cl. F03B 13/22

(52) U.S. Cl. 290/53

(57) ABSTRACT

A device for generating energy from waves includes one or more pistons placed near the water line of a body of water, one or more floats attached to one end of the one or more pistons whereby the pistons and attached one or more floats move up and down as waves action passes by the piston(s) and attached float(s), a crankshaft attached to the other end of the one or more pistons, and an electric generator in communication with the crankshaft. In these embodiments, the energy from the wave action is transmitted to the electric generator, whereby the electric generator produces electricity when the crankshaft is actuated by the energy transmitted from the float and piston moving from the wave action.

### CROSS-REFERENCES TO OTHER RELATED PATENT APPLICATIONS

This application claims the benefit of U.S. provisional Application No. 61/371,000, filed Aug. 5, 2011 which is incorporated by reference in which is incorporated herein by reference in its entirety for all purposes.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND

This invention relates generally to the field of harnessing energy from waves such as tidal waves and similar wave movements. More specifically, the claimed subject matter relates to devices and systems for producing electrical energy using the action of tidal waves.

### SUMMARY

According to one aspect of the claimed subject matter, there is provided a device for using energy derived from tidal waves in order to produce electric energy.

According to another aspect of the inventive subject matter, embodiments provide a lower cost alternative to produce electricity while minimizing pollution to the ocean waters and harm to marine life.

In one embodiment, a device for generating energy from waves includes one or more pistons placed near the water line of a body of water, one or more floats attached to one end of the one or more pistons whereby the pistons and attached one or more floats move up and down as waves action passes by the piston(s) and attached float(s), a crankshaft attached to the other end of the one or more pistons, and an electric generator in communication with the crankshaft. In these embodiments, the energy from the wave action is transmitted to the electric generator, whereby the electric generator produces electricity when the crankshaft is actuated by the energy transmitted from the float and piston moving from the wave action.

In other embodiments, there is an energy transmission device positioned between the crankshaft and the electric generator so that the energy is transmitted from the crankshaft to the electric generator via the energy transmission device. Other embodiments include two or more crankshafts instead of one crankshaft. In other embodiments, the electric generator is two or more electric generators.

### BRIEF DESCRIPTION OF THE DRAWINGS

FIG. 1 depicts schematically a tidal wave energy harnessing device that can be used in some embodiments of inventive subject matter.

### DETAILED DESCRIPTION

Embodiments of the claimed subject matter are directed to devices and systems for harnessing energy from tidal movements. In several of the embodiments, power is generated by an electric generator that is connected to a crankshaft which itself is connected to one or more pistons having one or more buoys attached to the one or more pistons. The pistons are able to move up and down as the waves pass by the device thereby raising and lowering the attached one or more buoys.

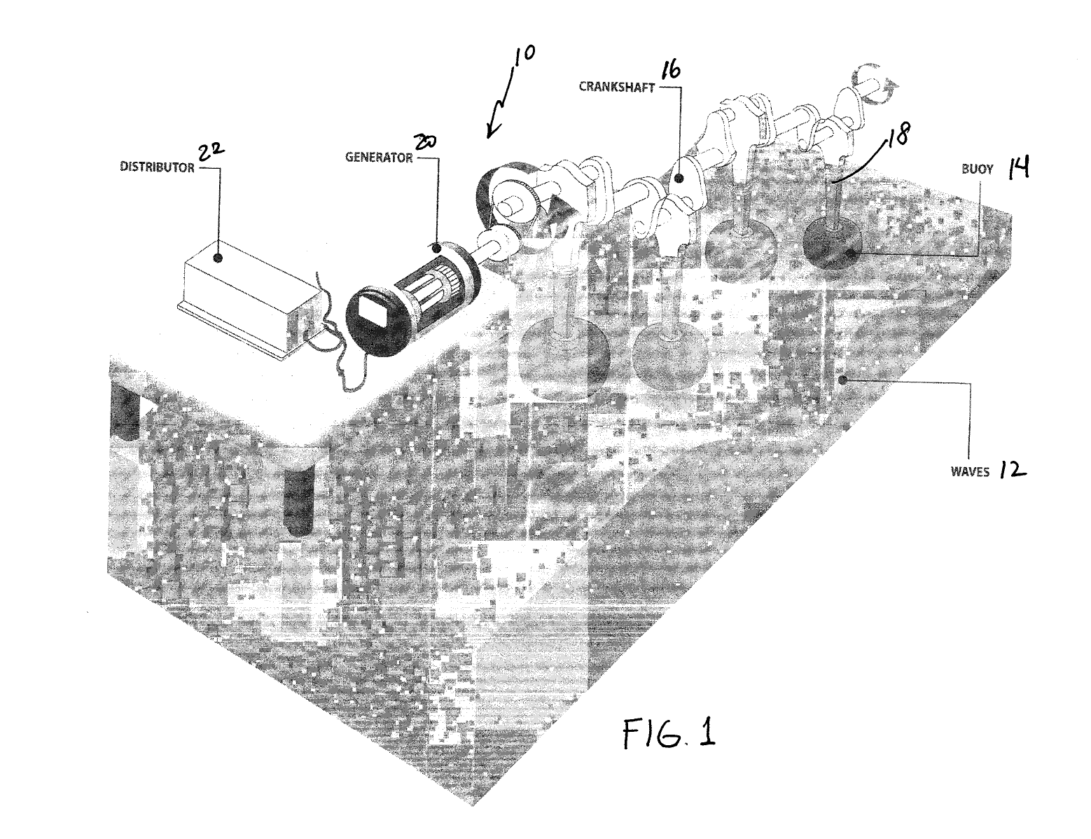

With reference now to FIG. 1, a device 10 is show positioned above waves 12. Buoys 14 are positioned about the water line so that they raise and lower with the wave movement of the waves 12. The crankshaft 16 is turned as the pistons 18 move with the movement of the buoys 14. This movement is used to turn the generator 20 thereby producing power which is transmitted out of the device 10 utilizing distributor 22.

The disclosed embodiments use the power of waves such as tidal waves and tidal movements to produce electric energy via an electric generator having a crankshaft that is connected to one or more pistons that move up and down as the tide passes by the device causing the buoys riding at or near the surface of the waves are driven up and down. Any suitable one or more electric generators, crankshafts, pistons and buoys known to those skilled in the art may be used in combination to derive energy from the waves. The waves can be tidal waves or any other type of fluid wave. In many embodiments, the buoys are positioned so that they move up and down near the surface of a body of water and the buoys move up and down relative to the wave action as the waves progress in their normal courses of action across the body of water. The body of water may be an ocean, sea, lake or any other suitable body of water. In many embodiments, the buoys are positioned at or around the water line and not a large distance below the ocean waters. The buoys can be positioned shallow in the body of water to avoid causing injury to wild life and humans. Positioning of the buoys near the water line, for example from zero feet to ten feet below the water line, allow easier maintenance of the buoys and piston portions that are positioned under the water line avoiding the need to have professional divers and/or underwater welders perform the maintenance.

In many of the embodiments, the piston is in communication with the buoy and the crankshaft. As the one or more pistons move up and down in conjunction with the wave action, the one or more pistons turn at least one crankshaft which itself is connected to an electric generator. In these embodiments, this wave action or movement is perpetual as tidal waves over large bodies of water never stop moving.

In these embodiments, the lack of exhaust or emissions released by the embodiments into the atmosphere contributes to the health of the global environment thereby aiding in slowing global warming. In many of the embodiments, the

In one embodiment, the device is comprised of the following: (a) a float that is attached to the base of a piston whereby the piston and attached float move up and down as waves action passes under the float; (b) a crankshaft attached to the piston as well as a crankshaft so that the energy from the wave action is transmitted to an electric generator, whereby the electric generator produces electricity when the crankshaft is actuated by the energy transmitted from the float and piston moving from the wave action. The wave action can be transmitted from the crankshaft to the electric generator via any suitable energy transmission device known to those skilled in the art.

In this embodiment, the float is connected to the piston, the piston is connected to a crankshaft, the crankshaft is connected to transmission device, and the transmission device is connected to an electric generator which will produce electricity using the movement of the tides or waves which pushes the pistons up and down.

In these embodiments, the tidal wave passes under the float which is attached to the piston. The action of the waves moves the one or more pistons up and down, which in turn move or actuate the crankshaft, which in turn moves or actuates the transmission like device, which then moves or actuates the electric generator thereby producing electricity which can then be stored locally or sent out to an electric distribution company for distribution to others such as the clients of the company.

In some embodiments, for instance on a smaller scale, several foam floats or the like can be attached to several pistons that are each connected to a crankshaft or any suitable device. This crankshaft is then attached directly to a generator or a simple energy transmission component having an electric generator attached. In many embodiments, these components can be placed in a protective housing and/or positioned on top of an area where there are waves (such as tidal waves) which will provide the energy in the form of wave action that can be used to make this device operate.

Many embodiments of the inventive subject matter can also be used to operate large pumps or other devices which themselves can be used to perform other actions such as to suction oil spills. As two thirds of the planet is covered by ocean water, embodiments can be used in many locations over a body of water allowing an electric plant in many previously undesirable locations and in any suitable size and capacity. The produced electricity is only limited by the action of the waves which itself can be unlimited and the amount of energy produced can be substantial. Many of the embodiments can be built, maintained and operated at a low cost and studies can be performed to find more optimal locations where the wave action is higher. Additionally, in many embodiments special doors can be manufactured to control the amount of waves or tidal waves that is needed to move the one or more pistons. In other embodiments, hurricane resistant structures can be used to encase the components and the associated electric producing and transmitting elements. These described embodiments address the high demand for electricity in an environmentally friendly manner.

Other devices such as tidal turbines, tidal propellers and the like work using the tidal waves but can heavily damage the environment including the wildlife and local population, They can also be difficult and costly to maintain. In one of the simplest embodiments, the embodiment acts in a fashion similar to a gas engine. A piston, crankshaft and generator which is activated be the movement of the waves instead of a gas explosion in a gas powered engine. The present embodiments in contrast can be safer, better, more reliable, and less costly to maintain over time. They can be very simple to manufacture using off the shelf components using simple construction techniques. In embodiments with floats and pistons positioned above the water, damage to marine life as well as humans can be minimized.

Although the foregoing embodiments have been described in some detail by way of illustration and example for purposes of clarity and understanding, it will be apparent to those of ordinary skill in the art in light of the teaching of this invention that certain changes and modifications may be made thereto without departing from the spirit or scope of the appended claims.

What is claimed is:

1. A device for generating energy from waves comprising:
(a) a piston placed near the water line of a body of water;
(b) a float attached to one end of the piston whereby the piston and attached float move up and down as waves action passes by the piston and attached float;
(c) a crankshaft attached to the other end of the piston;
(d) an electric generator in communication with the crankshaft;
wherein the energy from the wave action is transmitted to the electric generator, whereby the electric generator produces electricity when the crankshaft is actuated by the energy transmitted from the float and piston moving from the wave action.

2. The device for generating energy from waves of claim 1 further comprising an energy transmission device positioned between the crankshaft and the electric generator so that the energy is transmitted from the crankshaft to the electric generator via the energy transmission device.

3. The device for generating energy from waves of claim 1 wherein said piston is two or more pistons.

4. The device for generating energy from waves of claim 1 wherein said float is two or more floats.

5. The device for generating energy from waves of claim 1 wherein said crankshaft is two or more crankshafts.

6. The device for generating energy from waves of claim 1 wherein said electric generator is two or more electric generators.

7. The device for generating energy from waves of claim 1 wherein said float is constructed of foam.
